(19) United States
(12) Patent Application Publication
(10) Pub. No.: US 2018/0000112 A1
(43) Pub. Date: Jan. 4, 2018

(54) A METHOD OF RAPIDLY COATING A CONFECTIONERY AND THE COATED CONFECTIONERY

(71) Applicant: Intercontinental Great Brands LLC, East Hanover, NJ (US)

(72) Inventors: Cesar Carlos Elejalde, Randolph, NJ (US); Zoltan Husz, Gilching (DE); Simone Wieland, München (DE); Alexis Detavernier, Munchen (DE); Ewelina Bogdan-Smigielska, Munchen (DE); Joern Holm Hansen, Unterhaching (DE); Serena Melanie Müller, Clinton, NJ (US)

(21) Appl. No.: 15/543,440

(22) PCT Filed: Feb. 2, 2016
(86) PCT No.: PCT/US2016/016050

§ 371 Date: Jul. 13, 2017

Related U.S. Application Data
(60) Provisional application No. 62/111,028, filed on Feb. 2, 2015.

(51) Int. Cl. A23G 3/54; A23G 4/10; A23G 3/42; A23G 3/34; A23G 3/26; A23G 4/20; A23G 4/02

(52) U.S. Cl. CPC A23G 3/54; A23G 4/20; A23G 4/10; A23G 4/025; A23G 3/0065; A23G 3/26; A23G 3/0085; A23G 3/42

(57) ABSTRACT

A method of rapidly coating a confectionery is described. The method includes the steps of providing a confectionery core, forming a first-coating surrounding the confectionery core by applying at least one layer of a first syrup followed by a first coating powder to the confectionery core to form the first-coating, and forming a final coating surrounding the first-coating by applying at least one layer of a finishing syrup to the first-coating to form the final-coating.

### BACKGROUND OF THE INVENTION

Coated confectioneries, such as, coated candies and coated chewing gums are popular confectionery products. Conventionally, coated confectioneries are prepared by panned coating process. Coating a confectionery by a panning process is very time and energy consuming.

Conventional batch-type panning process typically takes about 5-8 hours to coat a confectionery. Total coating time depends on a number of factors, such as, equipment, amount of desired coating, nature of ingredients etc.

In conventional chewing gum coating processes, chewing gum centers (also known as chewing gum cores) are coated with sweetener or sugar syrups. The sweetener-syrup is applied in successive layers. The sweetener-syrup layers are typically applied by spraying the sweetener-syrup on the chewing gum cores. In conventional methods, after one layer of sweetener syrup is applied, the layer is allowed to dry before next layer of sweetener syrup is applied. The sweetener layers crystallize and a hard coating is formed around the chewing gum centers. Since each sweetener-syrup layer needs to be dried and crystallized before the next layer can be applied, the sequential application of multiple sweetener-syrup layers is a time-consuming and energy intensive process.

During the drying step of the panning process, a low humidity hot air is applied. The air temperature cannot exceed the chewing gum core melting point in order to avoid deformation. The drying air temperature is usually between about 20-30° C. Drying at low temperatures takes longer than drying at higher temperatures, thereby extending the total time required for coating.

Conventional methods of chewing gum coating are described in background section of U.S. Pat. No. 7,810,446.

In view of the above challenges, it is noted that there is a need to provide new methods of rapidly coating chewing gum cores. The new method should be less time-consuming, require less energy, and should not adversely affect the final product quality in terms of sensory attributes and look-and-feel of the product.

The present inventors have surprisingly found a new method that provides significant time reduction when compared to conventional batch panning methods. The potential time reduction is specific to the actual product, ingredients used, and the amount of coating required. Nonetheless, the present inventors found that in most cases 20-40% time reduction over conventional batch panned coating method was possible.

### BRIEF DESCRIPTION OF EMBODIMENTS OF THE INVENTION

One embodiment is a method of rapidly coating a confectionery comprising providing a confectionery core; forming a first-coating surrounding the confectionery core comprising applying at least one layer of a first syrup followed by a first coating powder to the confectionery core to form the first-coating; forming a final-coating surrounding the first-coating comprising applying at least one layer of a finishing-syrup to the first-coating to form the final-coating.

Another embodiment is a method of rapidly coating a confectionery comprising providing a confectionery core; forming a first-coating surrounding the confectionery core comprising applying at least one layer of a first syrup followed by a first coating powder to the confectionery core to form the first-coating; forming a second-coating surrounding the first-coating comprising applying at least one layer of a second syrup followed by a second coating powder to the first-coating to form the second-coating; forming a final-coating surrounding the second-coating comprising applying at least one layer of a finishing syrup to the second-coating to form the final-coating.

A further embodiment is a coated confectionery comprising a confectionery core; a first-coating surrounding the confectionery core, wherein the first coating comprises dried first-syrup and a first coating-powder; and a final-coating surrounding the first-coating, wherein the final coating comprises dried finishing-syrup.

Another embodiment is a method of rapidly coating a confectionery comprising providing a confectionery core; forming a first-coating surrounding the confectionery core comprising applying at least one layer of a first syrup comprising a sugar alcohol followed by a first coating powder comprising a sugar alcohol to the confectionery core to form the first-coating; forming a second-coating surrounding the first-coating comprising applying at least one layer of a second syrup comprising a sugar alcohol followed by a second coating powder comprising a sugar alcohol to the first-coating to form the second-coating; wherein the sugar alcohol of the first syrup and the sugar alcohol of the first coating powder are different; and wherein the sugar alcohol of the second syrup and the sugar alcohol of the second coating powder are the same or different.

Yet another embodiment is a coating syrup for coating confectionery and chewing gum, the coating syrup comprising about 0.01 to about 20 weight percent pregelatinized hydroxypropyl pea starch; 0 to about 20 weight percent gum arabic; an emulsifier; and water, wherein all amounts are based on the total weight of the coating syrup.

A coated confectionery comprising a confectionery core; a coating surrounding the confectionery core, wherein coating comprises pregelatinized hydroxypropyl pea starch and a sugar alcohol, and optionally further comprises an additional binding agent, an emulsifier, or a combination thereof.

These and other embodiments are described in detail below.

### BRIEF DESCRIPTION OF THE DRAWINGS

The following Figures are exemplary embodiments, which do not limit the claims.

FIG. 1 is a graph showing percent of 100% hard coating versus percent penetration of coating.

FIG. 2 is a graph showing amount of force required to penetrate a certain distance through chewing gum coating versus the distance penetrated. The graph shows separate data points and lines corresponding to (a) a rapid coated chewing gum according to the invention, (b) a hard coated chewing gum coated according to conventional hard pan coating method, (c) a chewing coated only with agglomerate coating, and (d) theoretical calculations.

FIG. 3A is a microscopy image of the interior of a comparative sugar alcohol coating.

FIG. 3B is a microscopy image of the interior of a sugar alcohol and modified starch coating.

### DETAILED DESCRIPTION OF THE INVENTION

The present inventors surprisingly found that the disclosed rapid coating method enables coating of confectioneries in substantially less time compared to traditional hard panned coating methods. The inventors also found that the confectioneries coated by the rapid coating method have texture, hardness, and sensory properties substantially similar to conventional hard pan coated confectioneries.

In some embodiments, there is provided a method of rapidly coating a confectionery comprising providing a confectionery core; forming a first-coating surrounding the confectionery core comprising applying at least one layer of a first syrup followed by a first coating powder to the confectionery core to form the first-coating; forming a final-coating surrounding the first-coating comprising applying at least one layer of a finishing-syrup to the first-coating to form the final-coating.

In some other embodiments, there is provided a method of rapidly coating a confectionery comprising providing a confectionery core; forming a first-coating surrounding the confectionery core comprising applying at least one layer of a first syrup followed by a first coating powder to the confectionery core to form the first-coating; forming a second-coating surrounding the first-coating comprising applying at least one layer of a second syrup followed by a second coating powder to the first-coating to form the second-coating; forming a final-coating surrounding the second-coating comprising applying at least one layer of a finishing syrup to the second-coating to form the final-coating.

The confectionery core can comprise any suitable confectionery composition. Confectionery composition means an edible product comprising a sweet component. Confectionery compositions include medicinal preparations made with sugar, syrup, sugar alcohol, or honey, and sweet foods such as candy or pastry. Suitable confectionery compositions are well known in the art and include soft candy, chewy candy, hard candy, chewing gum, chocolate (including, for example, milk chocolate, dark chocolate, and semi-sweet chocolate), lozenges, etc. In some embodiments, the confectionery core comprises chewing gum.

In some embodiments, the first syrup, the second syrup, and the finishing syrup have the same composition. In some embodiments, the first syrup and the second syrup have the same composition, but the finishing syrup has a composition different from the first and the second syrups. In some other embodiments, the first syrup, the second syrup, and the finishing syrup have different compositions.

In some embodiments, the first coating-powder and the second coating powder have same composition. In some other embodiments, the first coating powder and the second coating powder have different compositions.

The method comprises a step of forming a first-coating surrounding the confectionery core. The step can comprise applying any suitable number of layers of a first syrup followed by a first coating-powder. For example, the step can comprise applying two to fifty layers of a first syrup followed by a first coating-powder. In some embodiments, the first coating-powder is applied immediately after applying a layer of the first syrup. In some embodiments, the first coating-powder is applied after applying two or more layers of the first syrup. In some embodiments, one or more layers of the first syrup are dried before application of the first coating powder. In some other embodiments, drying is carried out after application of the coating-powder on the layer of the first-syrup. In some other embodiments, drying is carried out after applying a layer of the first syrup, and also after applying the coating powder.

In some embodiments, the method comprises a step of forming a second-coating surrounding the first coating. The step can comprise applying any suitable number of layers of a second syrup followed by a second coating-powder. For example, the step can comprise applying two to fifty layers of the second syrup followed by the second coating-powder. In some embodiments, the second coating-powder is applied immediately after applying a layer of the second syrup. In some embodiments, the second coating-powder is applied after applying two or more layers of the coating syrup. In some embodiments, one or more layers of the second syrup are dried before application of the first coating powder. In some other embodiments, drying is carried out after application of the coating-powder on the layer of the first-syrup. In some other embodiments, drying is carried out after applying a layer of the second coating syrup, and also after applying the coating powder.

In some embodiments, the first syrup comprises a sugar alcohol and water. In some embodiments, the first syrup comprises a sugar alcohol, at least one binding agent, and water. In some other embodiments, the first syrup further comprises an emulsifier.

In some embodiments, the second syrup comprises a sugar alcohol and water. In some embodiments, the second syrup comprises a sugar alcohol, at least one binding agent, and water. In some other embodiments, the second syrup does not include a binding agent. In some other embodiments, the second syrup further comprises an emulsifier.

In some embodiments, the finishing syrup comprises a sugar alcohol and water. In some embodiments, the finishing syrup comprises a sugar alcohol, at least one binding agent, and water. In some other embodiments, the finishing syrup further comprises an emulsifier.

The sugar alcohols used in the first syrup, the second syrup, and the finishing syrup can be suitably chosen based on the desired properties of the syrups. Suitable sugar alcohols include maltitol, isomalt, sorbitol, xylitol, erythritol, mannitol, polyglucitols, polyglycitols, hydrogenated starch hydolysates, and combinations thereof.

Isomalt consists of disaccharide alcohols. Isomalt can be prepared by hydrogenating isomaltulose. Products of the hydrogenation can include 6-O-α-D-glucopyranosyl-D-sorbitol (1,6-GPS); 1-O-α-D-glucopyranosyl-D-sorbitol (1,1-GPS); 1-O-α-D-glucopyranosyl-D-mannitol (1,1-GPM); 6-O-α-D-glucopyranosyl-D-mannitol (1,6-GPM); and mixtures thereof. Some commercially available isomalt materials include an almost equimolar mixture of 1,6-GPS, and 1,1-GPM. Other isomalt materials can include pure 1,6-GPS; pure 1,1-GPS; pure 1,6-GP; or pure 1,1-GPM. Still other isomalt materials can include mixtures of 1,6-GPS; 1,1-GPS; 1,6-GPM; and 1,1-GPM at any ratio. Exemplary commercially available isomalt includes Isomalt ST, including Isomalt ST-M and Isomalt ST-PF, Isomalt GS, Isomalt M, Isomalt DC, and Isomalt LM available from BENEO GmbH, part of the Siidzucker Group. Isomalt ST has an almost equimolar mixture of 1,6-GPS (43-57%) and 1,1-GPM. Isomalt GS contains 1,6-GPS (75-80%) and 1,1-GPM.

In an embodiment, the isomalt has an almost equimolar mixture of 1,6-GPS and 1,1-GPM. In another embodiment, the isomalt has a mixture of 1,1-GPM and 75-80% 1,6-GPS.

In some embodiments, the sugar alcohol used in the first syrup is different from the sugar alcohol used in the second syrup and the finishing syrup. In some embodiments, the sugar alcohol used in the second syrup is different from the sugar alcohol used in the first syrup and the finishing syrup. In some embodiments, the sugar alcohol used in the finishing syrup is different from the sugar alcohol used in the first syrup and the second syrup. In some other embodiments, different sugar alcohols are used in each of the first syrup, the second syrup, and the finishing syrup.

In some embodiments, the first syrup includes only one sugar alcohol. In some embodiments, the first syrup comprises a combination of two or more sugar alcohols. In some embodiments, the first syrup includes maltitol. In some embodiments, the first syrup includes isomalt. In some embodiments, the first syrup includes xylitol.

The sugar alcohol can be included in a suitable amount depending on the desired properties of the syrup. In some embodiments, the first syrup comprises about 20 to about 90 weight percent of the sugar alcohol. Within the range of about 20 to about 90 weight percent, the amount of sugar alcohol can be about 30 to about 85 weight percent, specifically, about 55 to about 80 weight percent, more specifically about 60 to 75 weight percent. In one embodiment, the first syrup comprises about 60 to about 70 weight percent maltitol.

In some embodiments, the second syrup includes only one sugar alcohol. In some embodiments, the second syrup comprises a combination of two or more sugar alcohols. In some embodiments, the second syrup includes maltitol. In some embodiments, the second syrup includes isomalt. In some embodiments, the second syrup includes xylitol.

The sugar alcohol can be included in a suitable amount depending on the desired properties of the syrup. In some embodiments, the second syrup comprises about 20 to about 90 weight percent of the sugar alcohol. Within the range of about 20 to about 90 weight percent, the amount of sugar alcohol can be about 30 to about 85 weight percent, specifically, about 55 to about 80 weight percent, more specifically about 60 to 75 weight percent. In one embodiment, the second syrup comprises about 65 to about 75 weight percent maltitol.

In some embodiments, the finishing syrup includes only one sugar alcohol. In some embodiments, the finishing syrup comprises a combination of two or more sugar alcohols. In some embodiments, the finishing syrup includes maltitol. In some embodiments, the finishing syrup includes isomalt. In some embodiments, the finishing syrup includes xylitol.

The sugar alcohol can be included in a suitable amount depending on the desired properties of the syrup. In some embodiments, the finishing syrup comprises about 20 to about 90 weight percent of the sugar alcohol. Within the range of about 20 to about 90 weight percent, the amount of sugar alcohol can be about 30 to about 85 weight percent, specifically, about 55 to about 80 weight percent, more specifically about 60 to 75 weight percent. In one embodiment, the second syrup comprises about 60 to about 70 weight percent maltitol.

The first syrup, the second syrup, and the finishing syrup can include a suitable binding agent depending on the desired properties of the syrup. Suitable binding agents include gum arabic, pea starch, xanthan gum, carboxymethyl cellulose, methyl cellulose, hydroxypropylmethyl cellulose, starch, modified starches, inulin, konjac, chitosan, tragacanth, karaya, ghatti, larch, carageenan, alginate, chemically modified alginate, agar, guar, locust bean, psyllium, tara, gellan, curdlan, pullan, gelatin, pectin, and combinations thereof.

Modified starch can include, for example, physical, chemical, or physical and chemical modification of starch. Exemplary physical modifications include pregelatinization, drying, or a combination thereof. Exemplary chemical treatments include hydrolysis, substitution, crosslinking, or a combination thereof.

In an embodiment, the binding agent is a modified hydroxypropyl starch, such as the pregelatinized hydroxypropyl pea starch commercially available from Roquette under the name LYCOAT with two grades LYCOAT RS 780 (developing lower viscosity) and LYCOAT RS 720 (developing higher viscosity).

In some embodiments, the first syrup includes only one binding agent. In other embodiments, the first syrup includes two or more binding agents. In some embodiments, the first syrup includes gum arabic. In some other embodiments, the first syrup includes gum arabic and pea starch.

The binding agent may be included in a suitable amount depending on the desired properties of the syrup. In some embodiments, the first syrup comprises about 10 to about 50 weight percent of the binding agent. Within the range of about 10 to about 50 weight percent, the amount of binding agent can be about 12 to about 45 weight percent, specifically, about 15 to about 40 weight percent, more specifically about 20 to 30 weight percent. In one embodiment, the first syrup comprises about 10 to about 20 weight percent gum arabic, and about 5 to about 15 weight percent pea starch.

In some embodiments, the second syrup includes only one binding agent. In other embodiments, the second syrup includes two or more binding agents. In some embodiments, the second syrup includes gum arabic. In some other embodiments, the second syrup includes gum arabic and pea starch.

The binding agent may be included in a suitable amount depending on the desired properties of the syrup. In some embodiments, the second syrup comprises about 0.001 to about 50 weight percent of the binding agent. Within the range of about 0.001 to about 50 weight percent, the amount of binding agent can be about 0.01 to about 30 weight percent, specifically, about 0.05 to about 20 weight percent, more specifically about 0.05 to 5 weight percent. In one embodiment, the second syrup comprises about 0.1 to about 1 weight percent gum arabic, and about 0.05 to about 1 weight percent pea starch.

In some embodiments, the finishing syrup includes only one binding agent. In other embodiments, the finishing syrup includes two or more binding agents. In some embodiments, the finishing syrup includes gum arabic. In some other embodiments, the finishing syrup includes gum arabic and pea starch.

The binding agent may be included in a suitable amount depending on the desired properties of the syrup. In some embodiments, the finishing syrup comprises no binding agent. In some embodiments, the finishing syrup comprises about 0.001 to about 50 weight percent of the binding agent. Within the range of about 0.001 to about 50 weight percent, the amount of binding agent can be about 0.01 to about 30 weight percent, specifically, about 0.05 to about 20 weight percent, more specifically about 0.05 to 5 weight percent. In one embodiment, the finishing syrup comprises about 0.1 to about 1 weight percent gum arabic, and about 0.05 to about 1 weight percent pea starch.

The emulsifiers optionally used in the first syrup, the second syrup, and the finishing syrup can be suitably chosen based on the desired properties of the syrups. Suitable emulsifiers include polysorbates (polyoxyethylene sorbitan esters), glyceryl monostearate, lecithin, a fatty acid monoglyceride, a diglyceride, propylene glycol monostearate, sugar esters, polyglycerol fatty acid esters, polyglycerol polyricinoleate (PGPR), monoglycerides and combinations thereof. Suitable polysorbates include polysorbate 20, polysorbate 40, polysorbate 60, and polysorbate 80. In some embodiments, the emulsifier used is polysorbate 60.

In some embodiments, the first syrup includes only one emulsifier. In other embodiments, the first syrup includes two or more emulsifiers. In some embodiments, the first syrup includes polysorbate 60.

The emulsifier may be included in a suitable amount depending on the desired properties of the syrup. In some embodiments, the first syrup comprises about 0.001 to about 10 weight percent of the emulsifier. Within the range of about 0.001 to about 10 weight percent, the amount of emulsifier can be about 1.5 to about 8 weight percent, specifically, about 2 to about 5 weight percent. In one embodiment, the first syrup comprises about 1 to about 5 weight percent polysorbate 60.

In some embodiments, the second syrup and/or the finishing syrup includes one or more emulsifiers. The emulsifier may be included in a suitable amount depending on the desired properties of the syrup. In some embodiments, the second syrup does not include an emulsifier. In some embodiments, the third syrup does not include an emulsifier.

In some embodiments, the first syrup comprises maltitol, gum arabic, and water. In some other embodiments, the first-syrup comprises maltitol, gum arabic, pea starch, and polysorbate 60. In some embodiments, the first-syrup comprises about 25 to about 70 weight percent maltitol; about 10 to about 20 weight percent gum arabic; about 5 to about 15 weight percent pea starch; and about 1 to about 5 weight percent polysorbate. In some embodiments, the first-syrup comprises about 30 to about 50 weight percent maltitol; about 10 to about 20 weight percent gum arabic; about 5 to about 15 weight percent pea starch; and about 1 to about 5 weight percent polysorbate.

In some embodiments, the second syrup comprises maltitol, gum arabic, pea starch and water. In some embodiments, the second-syrup comprises about 65 to about 75 weight percent maltitol; about 0.1 to about 1 weight percent gum arabic; and about 0.05 to about 1 weight percent pea starch.

In some embodiments, the finishing syrup comprises maltitol, gum arabic, and pea starch. In some embodiments, the finishing-syrup comprises about 65 to about 75 weight percent maltitol; about 0.1 to about 1 weight percent gum arabic; and about 0.2 to about 5 weight percent pea starch.

Each of the first coating-powder and the second coating-powder comprises a sugar alcohol. Suitable sugar alcohols are described above in context of the syrups. In some embodiments, the first coating powder and the second coating powder comprise of the same sugar alcohol. In other embodiments, the first coating powder and the second coating powder comprise different sugar alcohols. In some embodiments, the coating powders comprise a combination of sugar alcohols.

In some embodiments, the first coating powder comprises isomalt. In some embodiments, the second coating powder comprises isomalt. In some embodiments, the first coating powder comprises maltitol. In some embodiments, the second coating powder comprises maltitol. In some embodiments, the first coating powder comprises a combination of isomalt and maltitol. In some embodiments, the second coating powder comprises a combination of isomalt and maltitol. In some embodiments, the first coating powder comprises isomalt. In some embodiments, the first coating-powder comprises isomalt and the second coating-powder comprises a combination of isomalt and maltitol.

In some embodiments, the step of forming the first-coating further comprises pre-cooling the confectionery core to a temperature in the range of 0° C. to about 20° C. before applying the at least one layer of the first syrup. The inventors found that precooling accelerates polymerization of different binding agents.

In some embodiments, the step of forming the first-coating further comprises drying the first-coating with air at a temperature of about 10° C. to about 20° C.

In some embodiments, wherein the step of forming the final-coating further comprises drying the final-coating with air at a temperature of about 20° C. to about 50° C.

In some embodiments, it was found that the rapidly coated confectionery possessed at least 80% of hardness of a conventional hard pan-coated confectionery at 100% penetration of the coating wherein the hardness was measured within two days of producing the rapidly coated confectionery. In some embodiments, it was found that the rapidly coated confectionery possessed at least 70% of hardness of a conventional hard pan-coated confectionery at 100% penetration of the coating wherein the hardness was measured within two days of producing the rapidly coated confectionery. In some embodiments, it was found that the rapidly coated confectionery possessed at least 60% of hardness of a conventional hard pan-coated confectionery at 100% penetration of the coating wherein the hardness was measured within two days of producing the rapidly coated confectionery.

In some embodiments, the final-coating comprises about 20 to 80 percent of the total weight of the coatings. Within the range of 20 to 80 weight percent, the final coating can be 30 to 70 weight percent, specifically about 40 to 60 weight percent, and more specifically about 45 to 55 weight percent.

There is also provided a coated confectionery comprising a confectionery core; a first-coating surrounding the confectionery core, wherein the first coating comprises dried first-syrup and a first coating-powder; and a final-coating surrounding the first-coating, wherein the final coating comprises dried finishing-syrup. In some embodiments, the coated confectionery is a chewing gum.

In some embodiments, the coated confectionery comprises a confectionery core; a first-coating surrounding the confectionery core, wherein the first-coating comprises dried first syrup and a first coating-powder; and a second-coating surrounding the confectionery core, wherein the second-coating comprises dried second syrup and a second coating-powder; and a final-coating surrounding the second-coating, wherein the final-coating comprises dried finishing-syrup. In some embodiments, the coated confectionery is a chewing gum.

In some embodiments, there is provided a coating syrup for coating confectionery and chewing gum, the coating syrup comprising about 0.01 to about 20 weight percent pregelatinized hydroxypropyl pea starch; 0 to about 20 weight percent gum arabic; an emulsifier; and water, wherein all amounts are based on the total weight of the coating syrup. Within the range of about 0.01 to about 20 weight percent, the pregelatinized hydroxypropyl pea starch can be about 0.1 to about 15 weight percent, specifically about 1 to about 10 weight percent. Within the range of about 0 to about 20, gum arabic can be about 0 to about 10 weight percent; specifically about 0 to about 3 weight percent. The emulsifier can be polysorbate 60 in an amount of about 0.001 to about 10 weight percent, specifically about 0.01 to about 5 weight percent, more specifically, about 0.1 to 3 weight percent.

In some other embodiments there is provided a coated confectionery comprising a confectionery core; a coating surrounding the confectionery core, wherein coating comprises pregelatinized hydroxypropyl pea starch and a sugar alcohol, and optionally further comprises an additional binding agent, an emulsifier, or a combination thereof.

The foregoing and other embodiments are further illustrated by the following examples, which are not intended to limit the effective scope of the claims. All parts and percentages in the examples and throughout the specification and claims are by weight of the final composition unless otherwise specified.

### Example 1—Rapid Coating of Chewing Gum Cores

This Example illustrates an embodiment of the method of rapidly coating chewing gum pellets. The method comprises forming an initial coating on a chewing gum core followed by a final coating. The initial coating comprises of an agglomerate of a sugar alcohol and a liquid-syrup, and the final coating comprises coating with a finishing-syrup.

Present inventors surprisingly found that the rapidly coated chewing gum pellets appear similar to chewing gum pellets hard-coated by traditional panning process and possessed hardness and crunch substantially similar to those of chewing gum pellets hard-coated by traditional panning process.

Standard uncoated chewing gum pellets were obtained from Mondelez International Inc., East Hanover, N.J., USA. The chewing gum pellets had average mass of about 1.1 gram. The pellets were added to a panned coating apparatus and coated with a syrup. The syrup comprised 35 weight percent maltitol, 20 weight percent gum arabic, and 45 weight percent water. Dry charge of isomalt was applied to the layer of syrup surrounding the pellets. The cycle of applying a syrup followed by applying dry charge of isomalt was carried out two times to form an agglomerate coating substantially surrounding the chewing gum pellets. The pellets achieved about 12% weight gained in about 20 minutes.

The chewing gum pellets were further coated by conventional hard panning process using a 70 weight percent maltitol panning solution to form a hard coating surrounding the agglomerate coating.

After the hard panned coating, the chewing gum pellets had average mass of about 1.5 gram. The rapidly coated chewing gum pellets had a finish comparable to traditional hard pan-coated chewing gum pellets. Particularly, the rapidly coated pellets possessed smooth and even surfaces. It was further surprisingly found that the rapidly coated chewing gum pellets possessed crunch comparable to traditional hard pan-coated chewing gums without any negative sensory attributes.

### Example 2—Rapid Coating of Chewing Gum Cores

This Example illustrates another embodiment of the method of rapidly coating chewing gum pellets. This embodiment comprises forming a first-coating surrounding a chewing gum core, followed by forming a second-coating surrounding the first-coating, and forming a final-coating surrounding the second-coating. Each of the first and the second coatings comprises of an agglomerate of a sugar alcohol and a liquid syrup. The final coating is similar to conventional hard panned-coating.

Standard uncoated chewing gum pellets (cores) having peppermint flavor were obtained from Mondelēz Polska Production Sp. z o.o. Fabryka Gumy do Żucia ul. Smaków 1 49-318 Skarbimierz. 95 kilogram (Kg) of the chewing gum pellets were added to a DRIAM DRC 1200 coating machine (commercially available from Driam USA Inc.).

The chewing gum cores were coated with first syrup, which was a 60 brix° maltitol syrup comprising 15 weight percent gum arabic, 10 weight percent pea starch, and 2 weight percent of polysorbate 60. The pea starch was commercially available under tradename LYCOAT® from Roquette Pharmaceutical Inc. The first syrup was applied in three cycles as shown below in Table 1. Dry charge of isomalt was applied between applications of the syrup layers as shown in Table 1.

The cores were then coated with a second syrup, which was 71 brix° maltitol syrup comprising 3 weight percent gum arabic. The second syrup was applied in twelve cycles as shown in Table 1. Dry charge of maltitol was applied between applications of the syrup layers as shown in Table 1.

Finally, a finishing-syrup, which was 69 brix° maltitol syrup comprising 3 weight percent gum arabic, was applied to form the final coating. The finishing-syrup was applied in twenty cycles as shown in Table 1 below.

TABLE 1
Rapid Coating Summary

| | | | Amount of | |
|---|---|---|---|---|
| | Number of | Amount of syrup | isomalt/maltitol | |
| Syrup | cycles | per cycle (in Kg) | per cycle (in Kg) | |
| First syrup | 1 | 1.2 | 5 | (isomalt) |
| First syrup | 1 | 0.8 | 3 | (isomalt) |
| First syrup | 1 | 0.4 | 2.5 | (isomalt) |
| Second syrup | 2 | 0.3 | 0.3 | (maltitol) |
| Second syrup | 7 | 1 | 0.5 | (maltitol) |
| Second syrup | 1 | 1.2 | | |
| Second syrup | 2 | 1 | | |
| Third syrup | 8 | 1.5 | | |
| Third syrup | 6 | 1.2 | | |
| Third syrup | 6 | 0.8 | | |

The final product looked comparable to conventional hard-coated chewing gum pellets.

### Example 3—Rapid Coating of Chewing Gum Cores

This Example illustrates another embodiment of the method of rapidly coating chewing gum pellets. This embodiment comprises forming a first-coating surrounding a chewing gum core, followed by forming a second-coating surrounding the first-coating, and forming a final-coating surrounding the second-coating. Each of the first and the second coatings comprises of an agglomerate of a sugar alcohol and a liquid syrup. The final coating is similar to conventional hard panned-coating.

Standard uncoated chewing gum pellets (cores) having peppermint flavor were obtained from Mondelez International Inc. 95 kilogram (Kg) of the chewing gum pellets were added to a DRIAM DRC 1200 coating machine (commercially available from Driam USA Inc.).

The chewing gum cores were coated with first syrup, which was a 65 brix° maltitol syrup comprising 15 weight percent gum arabic, 10 weight percent pea starch, and 2 weight percent of polysorbate 60. The first syrup was applied in three cycles as shown below in Table 2.

The cores were then coated with a second syrup, which was 71 brix° maltitol syrup comprising 0.5 weight percent gum arabic and 0.2 weight percent pea starch. The second syrup was applied in seventeen cycles as shown in Table 2. Dry charge of isomalt was applied between applications of the syrup layers as shown in Table 2.

Finally, a finishing-syrup, which was 69 brix° maltitol syrup comprising 0.5 weight percent gum arabic and 3 percent pea starch, was applied to form the final coating. The finishing-syrup was applied in fourteen cycles as shown in Table 2 below.

The final product looked comparable to conventional hard-coated chewing gum pellets.

TABLE 2
Rapid Coating Summary

| | Number of | Amount of syrup | Amount of maltitol |
|---|---|---|---|
| Syrup | cycles | per cycle (in Kg) | per cycle (in Kg) |
| First syrup | 2 | 0.22 | |
| First syrup | 1 | 0.3 | |
| Second syrup | 1 | 0.2 | 0.1 |
| Second syrup | 1 | 0.4 | 0.3 |
| Second syrup | 8 | 1.2 | 0.45 |
| Second syrup | 1 | 0.9 | |
| Second syrup | 1 | 0.6 | |
| Second syrup | 1 | 0.5 | |
| Second syrup | 1 | 0.6 | |
| Second syrup | 1 | 0.5 | |
| Second syrup | 2 | 0.8 | |
| Third syrup | 2 | 1 | |
| Third syrup | 8 | 0.6 | |
| Third syrup | 4 | 0.9 | |

### Example 4—Rapid Coating of Chewing Gum Cores

Standard uncoated chewing gum pellets (cores) having peppermint flavor were obtained from Mondelez International Inc. 95 kilogram (Kg) of the chewing gum pellets were added to a DRIAM DRC 1200 coating machine (commercially available from Driam USA Inc.).

The chewing gum cores were coated with first syrup, which was a 65 brix° isomalt syrup comprising 15 weight percent gum arabic, 10 weight percent pea starch, and 2 weight percent of polysorbate. The first syrup was applied in six cycles as shown below in Table 3.

The cores were then coated with a second syrup, which was 71 brix° isomalt syrup comprising 0.5 weight percent gum arabic and 0.2 weight percent pea starch. The second syrup was applied in sixteen cycles as shown in Table 3. Dry charge of isomalt was applied between applications of the syrup layers as shown in Table 3.

Finally, a finishing-syrup, which was 69 brix° isomalt syrup comprising 0.5 weight percent gum arabic and 3 percent pea starch, was applied to form the final coating. The finishing-syrup was applied in seventeen cycles as shown in Table 3 below.

TABLE 3
Rapid Coating Summary

| | Number of | Amount of syrup | Amount of isomalt |
|---|---|---|---|
| Syrup | cycles | per cycle (in Kg) | per cycle (in Kg) |
| First syrup | 6 | 0.24 | |
| Second syrup | 1 | 0.4 | 0.4 |
| Second syrup | 1 | 0.7 | 0.6 |
| Second syrup | 8 | 2.2 | 0.9 |
| Second syrup | 1 | 1.7 | |
| Second syrup | 3 | 1.2 | |
| Second syrup | 1 | 0.9 | |
| Second syrup | 1 | 1.2 | |
| Third syrup | 1 | 2 | |
| Third syrup | 8 | 1 | |
| Third syrup | 4 | 1.8 | |
| Third syrup | 1 | 1 | |

The final product looked comparable to conventional hard-coated chewing gum pellets.

### Example 5

A standard uncoated chewing gum core was rapidly coated according to the method described in Example 1. Total coating of the chewing gum core comprises 60 percent by weight of hard panned coating, and 40 percent by weight of the agglomerate coating.

### Example 6—Hardness Testing of Rapidly Coated Chewing Gums

Chewing gum pellets as described in Example 5 were tested for hardness of the coating. Comparative chewing gum pellets coated with conventional hard panned coating process were also tested for hardness of coating.

The hardness testing was carried out using TA-XT2 texture analyzer (commercially available from Texture Technologies Corp.). To test hardness, a cylindrical probe was penetrated through the coating of the chewing gum. Amount of force required to penetrate through the coating was measured by the TA-XT2 testing machine.

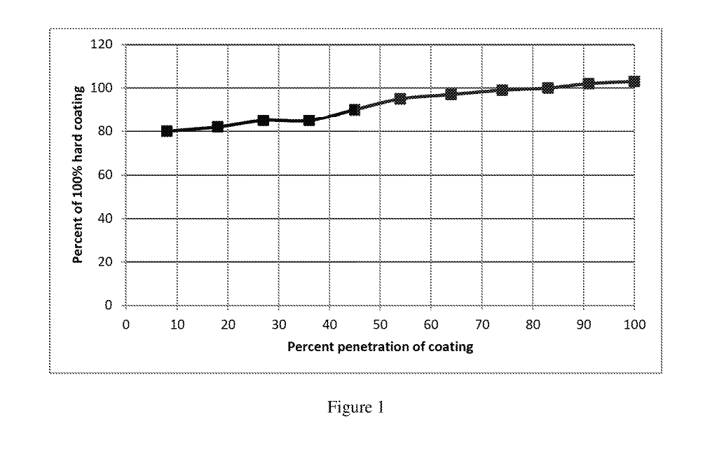

FIG. 1 shows the results of the hardness testing. As shown in FIG. 1, at 10 percent penetration though the entire pellet, the hardness of coating of Example 5 was about 80 percent of the hardness of comparative hard pan coated gum. Above 70 percent penetration, the hardness of rapid coated chewing gum is almost identical to that of comparative hard pan coated gum.

The hardness testing data illustrate the surprising finding that the rapid coated chewing gums having a dual structure coating (agglomerate coating and hard panned coating) possess substantially similar hardness when compared to those of completely hard pan-coated chewing gum compositions.

### Example 7—Hardness Testing of Rapidly Coated Chewing Gums

Coated chewing gum samples were prepared according to (a) method of Example 1, (b) conventional hard panning process, and (c) only agglomerate coating method described in Example 1. Hardness of the coated chewing gums (a), (b), and (c) was measured by the method described in Example 6.

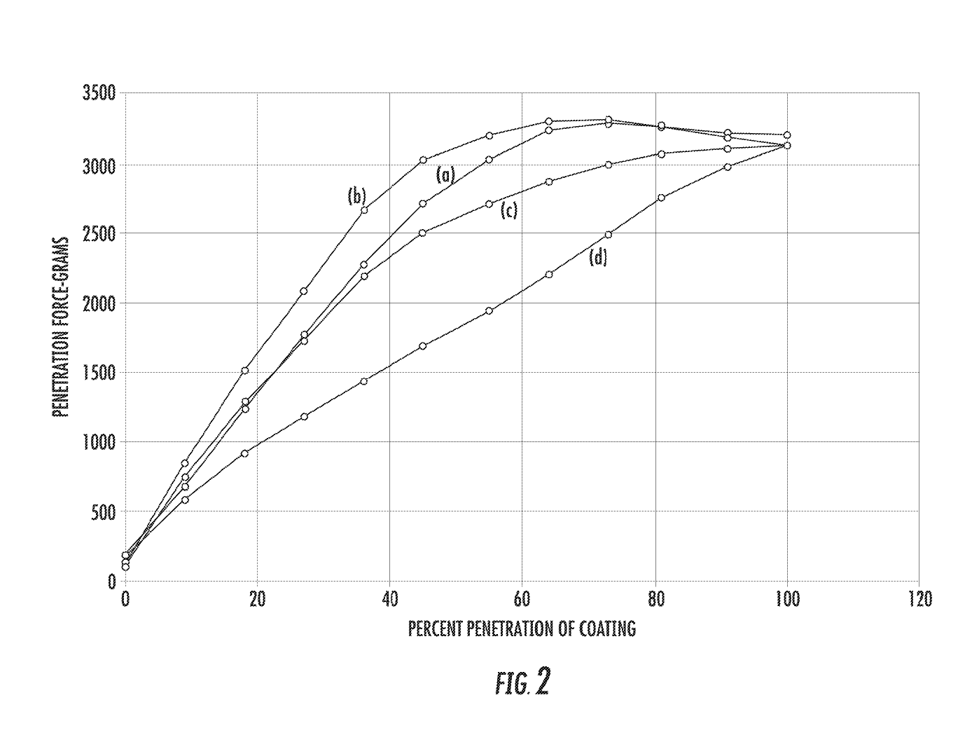

FIG. 2 shows the results of hardness testing of chewing gums (a), (b), and (c). FIG. 2 also shows expected (theoretical) hardness of a rapidly coated chewing gum based on the hardness data of the hard pan coated gum and only agglomerate coated gum.

The results shown in FIG. 2 illustrates the surprising finding that contrary to theoretical calculations the rapid coated chewing gums having a dual structure coating (agglomerate coating and hard panned coating) possess hardness similar to hard pan coated chewing gums.

### Example 8—Comparison of Conventional Hard-Panned Chewing Gum to Coated Chewing Gum Prepared by the Rapid Coating Process

In this example, six coated chewing gum pellet samples were prepared and examined to determine the effects of using a dual structure coating (agglomerate coating and hard panned coating, e.g. according to EXAMPLE 1) on coating structure, crystallization, and crunchiness compared to conventional hard-panned chewing gum products. Further, the overall time of the coating processes were compared.

Three control samples of conventionally hard-panned (HP) chewing gum pellets were prepared from different sugar alcohols: Maltitol HP Control, Isomalt HP Control, and Xylitol HP Control. Three test samples were precoated with Isomalt ST-PF (SP) and then conventionally hard-panned (HP) to attain same coating levels as the control samples: Isomalt SP Maltitol HP, Isomalt SP Isomalt HP, and Isomalt SP Xylitol HP.

The samples having the dual coating qualitatively maintained similar crunch texture to the control samples. Scanning electron microscopy image analysis verify similar packing and structure of the hard panning layers. Additionally, the agglomerate layer was found to be densely packed, which is associated with crunchiness. X-ray diffraction analysis verified that the agglomerate layer does not significantly impact the crystallization of hard panned layer.

### Example 9—Comparison of Conventional Hard-Panned Chewing Gum to Coated Chewing Gum Prepared by the Rapid Coating Process

In this example, a 100 kilogram trial of a conventional hard-panning process was compared with 100 kilogram trials of the dual structure coating process (agglomerate coating and hard panned coating, e.g. according to EXAMPLE 1) in terms of time saving for the overall process.

For the results in Table 4 below, all samples used maltitol syrup and maltitol hard panning syrup. For the dual coating process, the number of applications (“app”) is provided.

TABLE 4

| Coating process | time (hours) | % time saved |
|---|---|---|
| Control conventional hard-panning | 4.26 | 0% |
| Dual, 1 app Maltitol | 3.02 | 29% |
| Dual, 2 app Maltitol | 2.79 | 35% |
| Dual, 3 app Maltitol | 2.31 | 46% |
| Dual, 2 app Isomalt | 2.63 | 38% |
| Dual, 3 app Isomalt | 2.58 | 39% |

Larger trials were conducted on the dual coating process using 2 applications of the agglomerate layer prepared from maltitol syrup and isomalt powder, followed by maltitol hard-panning. One trial involved a 2 ton continuous process and a second trial involved 500 kilogram batch process. The time saving comparison to a conventional hard-panned process is shown in Table 5.

TABLE 5

| | | Cycle time | Cycle reduction |
|---|---|---|---|
| Process | Batch | (hours) | time |
| Conventional, | Control | 8.17 | — |
| Continuous, 2T | | | |
| Dual, Continuous, 2T | Batch 1 | 5.67 | 30.61% |
| Dual, Continuous, 2T | Batch 2 | 5.95 | 27.14% |
| Dual, Continuous, 2T | Batch 3 | 5.75 | 29.59% |
| Conventional, Batch, | Control | 7.50 | — |
| 500 kg | | | |
| Dual, Batch, 500 kg | Batch 4 | 5.50 | 26.67% |

### Example 10—Comparison of Conventional Hard-Panned Chewing Gum to Coated Chewing Gum Prepared by the Rapid Coating Process—Microscopy

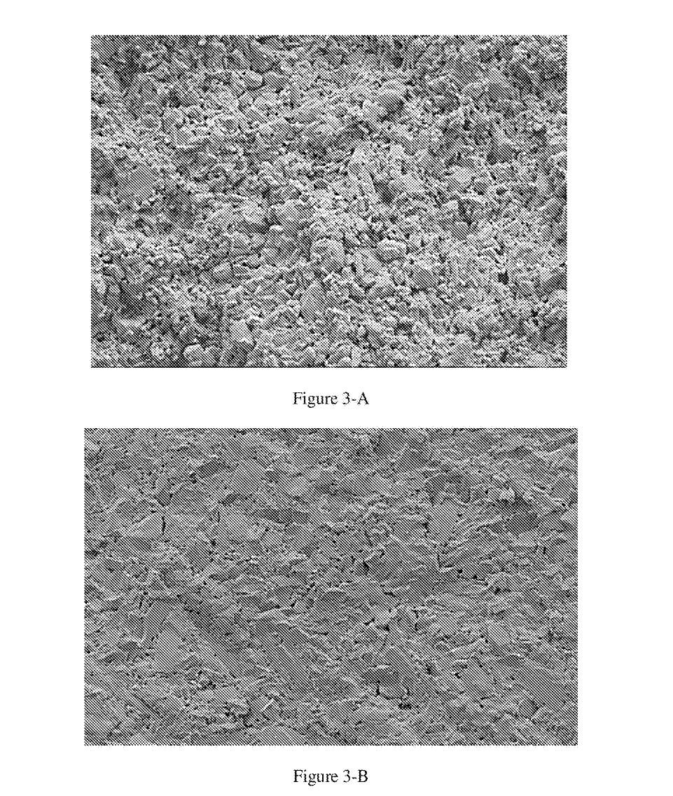

FIG. 3A is a microscopy image of the inner layer of a comparative traditional sugar alcohol syrup coated pellet chewing gum. To expose the inner layer, the pellet surface was scratched to expose the interior of the coating. The sugar alcohol syrup used in the coating further contained gum arabic. As can be seen in the image, the inner layer contains crystalline sugar alcohol of various sizes and a small number of pores are present (dark areas in the image).

FIG. 3B is a microscopy image of the inner layer of a coated pellet chewing gum prepared with a dual structure coating (agglomerate coating and hard panned coating). The agglomerate coating was prepared using a syrup comprising water, sugar alcohol, gum arabic, an emulsifier such as polysorbate 60, and LYCOAT RS780, a food modified starch, hydroxypropyl starch, based on pea. The sugar alcohol used in the coatings of the samples in FIGS. 3A and 3B were the same. Again, the pellet surface was scratched to expose the inner layer of the coating. As can be seen in the image, the inner layer is less porous and comprises polymerized binding agent. As opposed to the conventional coating, the crystals appear large with some compaction apparent.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A method of rapidly coating a confectionery comprising providing a confectionery core;
forming a first-coating surrounding the confectionery core comprising
applying at least one layer of a first syrup followed by a first coating-powder to the confectionery core to form the first-coating;
forming a final-coating surrounding the first-coating comprising applying at least one layer of a finishing-syrup to the first-coating to form the final-coating.

2. The method of claim 1, further comprising
forming a second-coating surrounding the first-coating comprising
applying at least one layer of a second syrup followed by a second coating-powder to the first-coating to form the second-coating.

3. (canceled)

4. The method of claim 2, wherein each of the first syrup, the second syrup, and the finishing-syrup comprises a sugar alcohol and water.

5. The method of claim 2, wherein each of the first syrup, the second syrup, and the finishing-syrup comprises a sugar alcohol, at least one binding agent, and water.

6.-7. (canceled)

8. The method of claim 4, wherein the sugar alcohol is selected from the group consisting of maltitol, isomalt, sorbitol, xylitol, erythritol, mannitol, polyglucitols, polyglycitols, hydrogenated starch hydolysates, and combinations thereof.

9. The method of claim 5, wherein the first syrup further comprises about 0.001 to 10 weight percent of an emulsifier.

10. (canceled)

11. The method of claim 5, wherein the first syrup comprises about 10 to 50 weight percent binding agent.

12. The method of claim 5, wherein each of the second syrup and the finishing-syrup comprises about 0.001 to 50 weight percent binding agent.

13. (canceled)

14. The method of claim 4, wherein each of the first coating-powder and the second coating-powder comprises a sugar alcohol independently selected from the group consisting of isomalt, sorbitol, maltitol, xylitol, erythritol, mannitol, polyglucitols, polyglycitols, hydrogenated starch hydolysates, and combinations thereof.

15. (canceled)

16. The method of claim 1, wherein the step of forming the first-coating further comprises pre-cooling the confectionery core to a temperature in the range of 0° C. to about 20° C. before applying the at least one layer of the first syrup.

17. The method of claim 1, wherein the step of forming the first-coating further comprises drying the first-coating with air at a temperature of about 10° C. to about 20° C.

18. The method of claim 1, wherein the step of forming the final-coating further comprises drying the final-coating with air at a temperature of about 20° C. to about 50° C.

19. The method according to claim 1, wherein the rapidly coated confectionery possess at least 80% of hardness of a conventional hard pan-coated confectionery at 100% penetration of the coating wherein the hardness is measured within two days of producing the rapidly coated confectionery.

20.-23. (canceled)

24. The method of claim 2, wherein the first-syrup comprises about 60 to about 70 weight percent maltitol; about 10 to about 20 weight percent gum arabic; about 5 to about 15 weight percent pea starch; and about 1 to about 5 weight percent polysorbate;
the second syrup comprises about 65 to about 95 weight percent maltitol; about 0.1 to about 1 weight percent gum arabic; and about 0.05 to about 1 weight percent pea starch; or
the finishing-syrup comprises about 65 to about 75 weight percent maltitol; about 0.1 to about 1 weight percent gum arabic; and about 0.2 to about 5 weight percent pea starch.

25.-26. (canceled)

27. The method of claim 1, wherein the final-coating comprises about 20 to 80 percent of the total weight of the coatings

28. A coated confectionery comprising
a confectionery core;
a first-coating surrounding the confectionery core, wherein the first coating comprises dried first-syrup and a first coating-powder; and
a final-coating surrounding the first-coating, wherein the final coating comprises dried finishing-syrup,
wherein at least one of the dried first syrup and the dried finishing syrup includes pea starch.

29. The coated confectionery of claim 28, further comprising
a second-coating surrounding the confectionery core, wherein the second-coating comprises dried second syrup and a second coating-powder
wherein at least one of the dried first syrup, the dried second syrup, and the dried finishing syrup includes pea starch.

30. (canceled)

31. The coated confectionery of claim 28, wherein the coated confectionery possesses at least 80% of hardness of a conventional hard pan-coated confectionery at 100% penetration of the coating, wherein the hardness is measured within two days of producing the rapidly coated confectionery.

32. (canceled)

33. The method of claim 2
wherein at least one of the first syrup, the second syrup, and the finishing syrup include pregelatinized hydroxypropyl pea starch.

34.-39. (canceled)

40. A coating syrup for coating confectionery and chewing gum, the coating syrup comprising
about 0.01 to about 20 weight percent pregelatinized hydroxypropyl pea starch;
about 0 to about 20 weight percent gum arabic;
an emulsifier; and
water,
wherein all amounts are based on the total weight of the coating syrup.

41. (canceled)
